(19) United States
(12) Patent Application Publication
(10) Pub. No.: US 2016/0207623 A1
(43) Pub. Date: Jul. 21, 2016

(54) ROTARY-WING AIRCRAFT WITH DUCTED ANTI-TORQUE DEVICE

(71) Applicant: Franklin D. Carson, New Hope, PA (US)

(72) Inventor: Franklin D. Carson, New Hope, PA (US)

(21) Appl. No.: 14/632,674

(22) Filed: Feb. 26, 2015

Related U.S. Application Data
(60) Provisional application No. 62/105,560, filed on Jan. 20, 2015.

(51) Int. Cl. B64C 27/82; B64C 27/46; B64C 27/04; B64C 5/16; B64C 1/26

(52) U.S. Cl. CPC B64C 27/82; B64C 5/16; B64C 1/26; B64C 27/04; B64C 27/46

(57) ABSTRACT

Embodiments of rotary-wing aircraft include a fuselage, and a main rotor assembly mounted for rotation on the fuselage. The rotary-wing aircraft also have an anti-torque device. The anti-torque device has a body that is contiguous with the fuselage, and a rotor mounted within a duct defined by the body.

### CROSS REFERENCE TO RELATED APPLICATIONS

This application is a non-provisional application of U.S. Application No. 62/105,560, filed Jan. 20, 2015, the contents of which are incorporated by reference herein in their entirety.

### BACKGROUND

1. Statement of the Technical Field

The inventive concepts disclosed herein relate to rotary-wing aircraft, such as helicopters, with a ducted anti-torque device for producing torque that counteracts the reactive torque generated by the aircraft's main rotor.

2. Description of Related Art

The use of ducted anti-torque rotors on rotary-wing aircraft is known. Ducted anti-torque rotors are used in lieu of conventional tail rotors, and can provide advantages such as increased aerodynamic efficiency; reduced potential for the rotor to strike trees, wires, and other hazards during takeoff and landing; increased ground-crew safety; and reduced noise levels. Ducted anti-torque rotors and conventional tail rotors generate torque that counteracts the reactive torque exerted on the aircraft by rotation of the aircraft's main rotor. This counteractive torque also facilitates directional control about the aircraft's vertical, or yaw axis.

Ducted anti-torque rotors, like conventional tail rotors, are mounted on the aft end of a tail boom that extends rearward from the aircraft's fuselage. The ducting that surrounds the rotor, and its underlying structure, add weight that otherwise would not be present with a conventional tail rotor. Because the ducted anti-torque rotor is located at the aft end of the tail boom, this additional weight can have a disproportionate effect on the aircraft's center gravity in comparison to other components that are not situated at such an extreme-aft position.

Shifting the center of gravity of a rotary-wing aircraft in the aft direction can necessitate the use of more forward cyclic control during level flight than otherwise would be needed, which in turn can lead to increased fuel consumption. An aft center of gravity also can make the aircraft less stable, and less controllable. An aft center of gravity can be especially problematic in the many medium and large size rotary-wing aircraft that use front-drive engines, as these types of engines usually necessitate placement of the aircraft's relatively heavy transmission aft of the center of gravity. Moreover, the ducting associated with a ducted anti-torque rotor can add to the effective frontal area of the aircraft for the purposes of drag calculation. The resulting need or desire to minimize the size and weight of the ducted anti-torque rotor may compel a designer to limit the length of the duct to a value that results in less-than-optimal aerodynamic performance of the rotor.

### SUMMARY

Embodiments of rotary-wing aircraft include a fuselage having a cabin that spans substantially an entire length of the fuselage. The rotary-wing aircraft further include a rotor assembly mounted on the fuselage for rotation about a first axis extending in a first direction. The rotor assembly has a mast, a hub mounted on the mast, and a plurality of blades mounted on the hub. The rotary-wing aircraft also include an engine that is mounted on the fuselage, mechanically coupled to the rotor assembly, and operative to generate a torque that causes the rotor assembly to rotate. The rotary-wing aircraft also have an anti-torque device. The anti-torque device has a body that is contiguous with the fuselage and defines a duct; and a rotor mounted within the duct for rotation about a second axis extending in a second direction.

Other embodiments of rotary-wing aircraft include a fuselage having a cabin that spans substantially an entire length of the fuselage. The rotary-wing aircraft further include a rotor assembly mounted for rotation on the fuselage. The rotor assembly has a mast, a hub mounted on the mast, and a plurality of blades mounted on and extending radially outward from the hub. The rotary-wing aircraft also include an engine that is mounted on the fuselage, mechanically coupled to the rotor assembly, and operative to generate a torque that causes the rotor assembly to rotate. The rotary-wing aircraft also have an anti-torque device. The anti-torque device includes a body that is mounted on the fuselage and defines a duct; and a secondary rotor mounted for rotation within the duct.

The secondary rotor is operative to generate a torque that counteracts a torque exerted on the fuselage in response to the torque that causes the rotor assembly to rotate. A distance between an axis of rotation of the rotor assembly and an axis of rotation of the secondary rotor is less than one-half of a maximum diameter of the rotor assembly.

Other embodiments of rotary-wing aircraft include a fuselage, and a rotor assembly mounted for rotation on the fuselage having a cabin that spans substantially an entire length of the fuselage. The rotary-wing aircraft further include a mast, a hub mounted on the mast, and a plurality of blades mounted on and extending radially outward from the hub. The rotary-wing aircraft also include an engine that is mounted on the fuselage, mechanically coupled to the rotor assembly, and operative to generate a torque that causes the rotor assembly to rotate. The rotary-wing aircraft also have an anti-torque device. The anti-torque device includes a body mounted on the fuselage and defining a duct; and a secondary rotor mounted for rotation in the duct and operative to generate a force substantially perpendicular to a longitudinal axis of the fuselage. A ratio of a maximum diameter of the secondary rotor to a length of the duct is approximately 1.5 to approximately 2.0.

### BRIEF DESCRIPTION OF THE DRAWINGS

Embodiments will be described with reference to the following drawing figures, in which like numerals represent like items throughout the figures and in which:

FIG. 1 is a side view of a rotary-wing aircraft equipped with a ducted anti-torque device;

FIG. 2 is a top view of the rotary-wing aircraft shown in FIG. 1; and

FIG. 3 is a magnified, cross-sectional view of the area designated “B” in FIG. 2, taken along the line “A-A” of FIG. 1.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

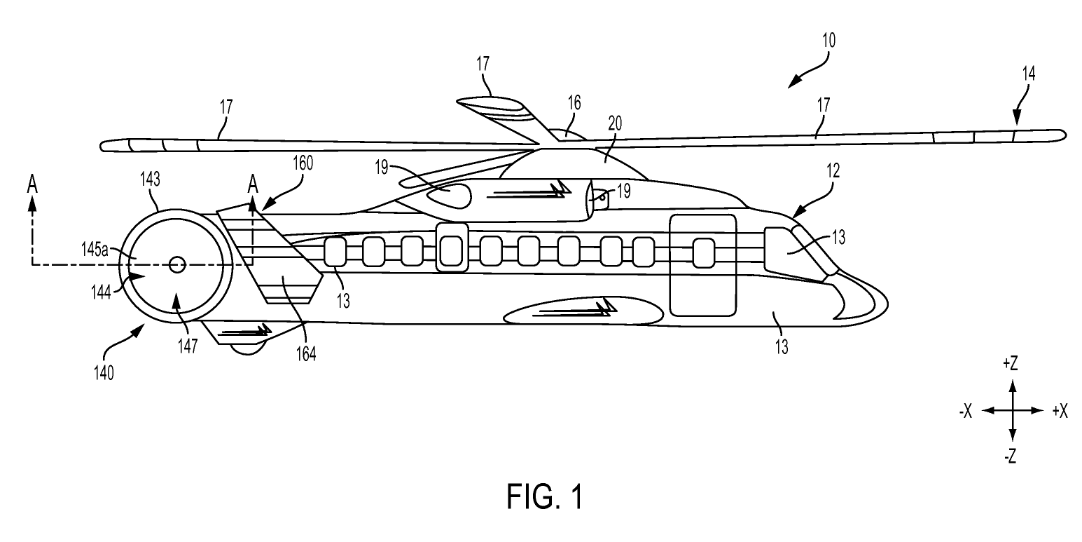

The figures depict a rotary wing aircraft 10. The aircraft 10 comprises a main body or fuselage 12. The fuselage 12 includes a skin 13 formed by interconnected panels of aluminum, and a rigid aluminum frame (not shown) on which the skin 13 is mounted. The skin 13 and frame can be formed from other materials, including composite materials, in alternative embodiments. The interior volume of the fuselage 12 defines a cabin 13 that accommodates one or more pilots; passengers; and cargo. The cabin 13 is partially visible in FIG. 1 through the windows of the aircraft 10. The cabin 13 spans substantially the entire length, i.e., x-axis dimension, of the fuselage 12.

The aircraft 10 further comprises a main rotor assembly 14 that rotates in a counterclockwise direction when viewed from above. The main rotor assembly 14 can be of conventional design. The main rotor assembly 14 includes a hub 16, and five main rotor blades 17 pivotally mounted on the hub 16. Alternative embodiments can include a main rotor assembly having more, or less than five main rotor blades 17. The main rotor assembly 14 further includes a mast, or drive shaft 18 fixedly coupled to the hub 16.

The aircraft 10 also comprises two engines 19 (one of which is partially visible in FIG. 1), and a transmission (not shown). Alternative embodiments can include one, or more than two engines 19. The engines 19 and the transmission are mounted on the fuselage 12, proximate the top thereof. The drive shaft 18 is coupled to the transmission so that torque generated by the engines 19 imparts rotation to the drive shaft 18 and the attached rotor blades 17. Rotation of the rotor blades 17 generates lift that suspends the aircraft 10 above the ground.

The lift generated by each rotor blade 17 is related to the orientation of the rotor blade 17 in relation to its direction of travel. More particularly, increasing the pitch of each rotor blade 17 in relation to its direction of travel increases the angle of attack of the rotor blade 17, and thereby increases the lift generated by the rotor blade 17.

The main rotor assembly 14 further comprises a swash plate assembly. The swash plate assembly is located beneath an aerodynamic fairing 20 shown in FIG. 1. The swash plate assembly can be of conventional design. The swash plate assembly can include a plurality of rotating control tubes and a plurality of non-rotating control tubes. The swash plate assembly can also include a rotating swash plate and a non-rotating swash plate each positioned around the drive shaft 18, and a plurality of bearings positioned between the rotating swash plate and the non-rotating swash plate. The rotating swash plate is fixedly coupled to the drive shaft 18, and thus rotates with the drive shaft 18.

Control inputs from the pilot are transmitted by various linkages to the non-rotating control tubes. The non-rotating control tubes deflect upwardly or downwardly in response to the inputs, which in turn deflects the non-rotating swash plate. The deflection of the non-rotating swash plate is transferred to the rotating swashplate via the bearings. The resulting deflection of the rotating swash plate imparts upward or downward movement to the rotating control tubes, which in turn alters the pitch of the rotor blades 17 attached thereto.

Specific details of the swash plate assembly are provided for exemplary purposes only. Alternative embodiments of the aircraft 10 can be equipped with other means for altering the pitch of the rotor blades 17.

The aircraft 10 also comprises a collective control to control the overall lift generated by the main rotor assembly 14. The collective control can be a conventional collective control that, in response to pilot input, simultaneously alters the respective pitch angle, and the resulting angle of attack, of each rotor blade 17 by approximately the same amount.

The aircraft 10 further comprises a cyclic control. The cyclic control can be a conventional cyclic control that provides directional control for the aircraft 10. The cyclic control causes the rotor blades 17 to deflect in relation to the hub 16 on a cyclical basis, i.e., the cyclic control causes the pitch, and the resulting angle of attack of each rotor blade 17 to vary throughout each revolution of the rotor blade 17. This cyclical variation causes the main rotor assembly 14 to generate asymmetric lift. The asymmetric lift causes the aircraft 10 to pitch or roll, and thereby provides directional control for the aircraft 10.

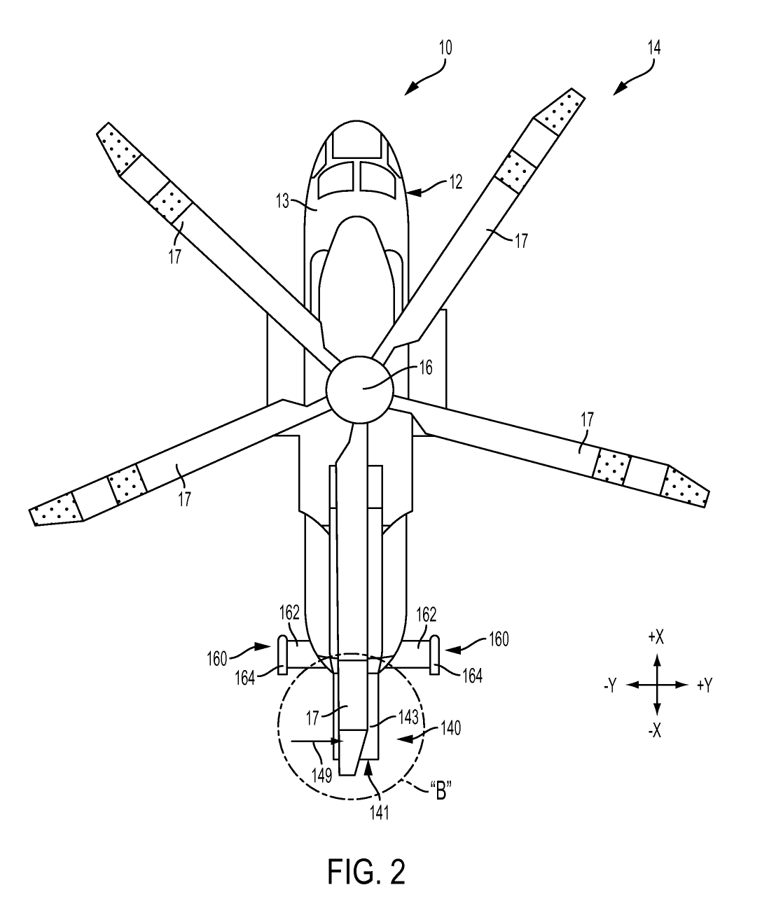

The aircraft 10 also comprises an anti-torque device 140. The anti-torque device 140 has a body 141. The body 141 includes a rigid aluminum frame 142 and an aluminum skin 143. The skin 143 is formed by interconnected panels of aluminum mounted on the frame 142. The frame 142 and the skin 143 can be formed from other materials, including composite materials, in alternative embodiments. The anti-torque device 140 is mounted on the rearward end of the fuselage 12, and is positioned directly beneath the plane of rotation of the main rotor blades 17 as shown in FIGS. 1 and 2.

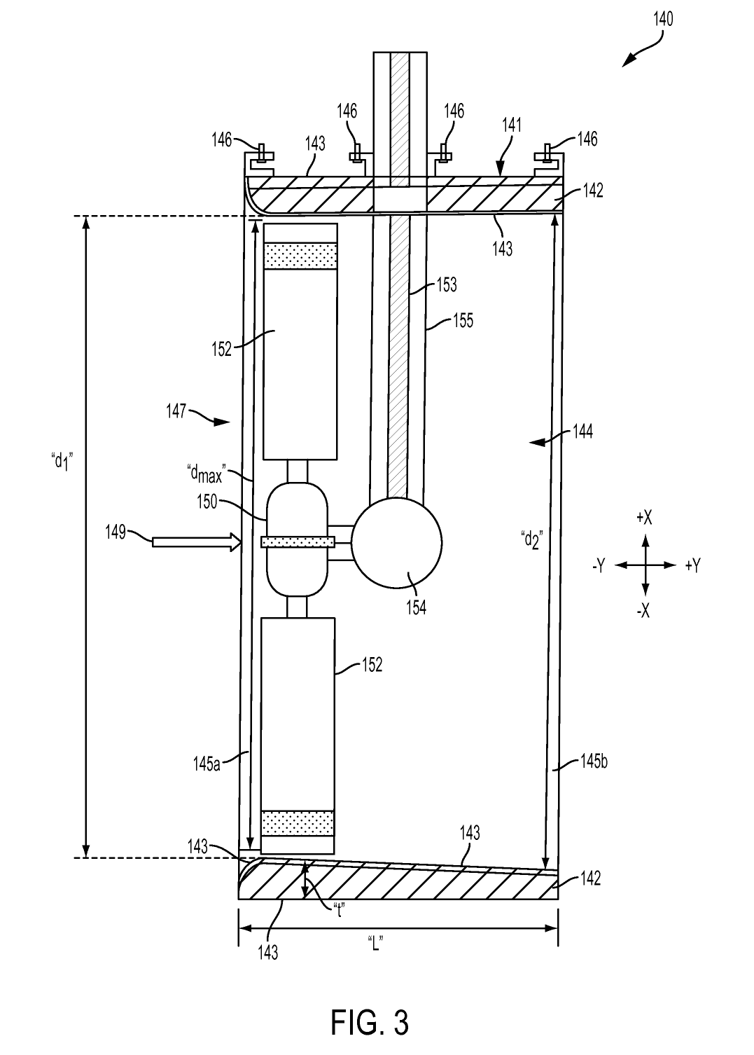

The frame 142 is visible in the cross-sectional view of FIG. 3. The frame 142 has a substantially cylindrical configuration. Other configurations can be used for the frame 142 in alternative embodiments. The anti-torque device 140 is mounted contiguously to the fuselage 12, i.e., the anti-torque device 140 is connected directly to, or formed integrally with the fuselage 12. In the embodiment disclosed herein, the anti-torque device 140 can be attached to a rearward-most portion of the fuselage 12 by brackets and fasteners denoted in FIG. 3 by the reference characters 146. Other types of attachment means can be used in the alternative. In other alternative embodiments, the frame 142 can be integrally formed with the frame of the fuselage 12.

The skin 143 defines a substantially cylindrical duct 144, shown in FIGS. 1 and 3. The duct 144 has a first end 145a that acts as an inlet or entrance for the air flowing through the duct 144, and a second end 145b that acts as an outlet or exit. The direction of airflow through the duct is denoted by the arrow 149 in FIGS. 2 and 3. The portions of the frame 142 and the overlying skin 143 proximate the first end 145a are rounded as shown in FIG. 3, to encourage smooth and uniform airflow into the duct 144.

The duct 144 has an x-direction dimension, or diameter, at or proximate its first end 145a; this diameter is denoted in FIG. 3 by the character “d1.” The duct 144 has a y-direction dimension, or length, denoted in FIG. 3 by the character “L.” The diameter of the duct 144 increases slightly along its length, so that the duct 144 reaches is maximum diameter at or proximate the second end 145b; this diameter is denoted in FIG. 3 by the reference character “d2.” In the exemplary anti-torque device 140, the diameter d1 is approximately eight feet, and the length L of the duct 144 is approximately four feet. The frame 142 and the overlying skin 143 have a combined maximum thickness denoted in FIG. 3 by the character “t.” The maximum thickness “t” in the exemplary anti-torque device 140 is approximately six inches. Specific values for the dimensions d1, L, and t are provided for exemplary purposes only. These dimensions are application-dependent, and can vary from the values specified herein. For example, in alternative embodiments the body 141 of the anti-torque device 140 can be sized to span approximately the entire width, i.e., “y” dimension, of the rearward end of the fuselage 12, giving the duct 144 a length L approximately equal to said width.

The anti-torque device 140 further includes a secondary rotor 147 positioned for rotation within the duct 144, as shown in FIGS. 1 and 3. The secondary rotor 147 includes a hub 150, and eight blades 152 mounted on the hub 150. Alternative embodiments can include a secondary rotor 147 having more, or less than eight blades 152. The secondary rotor 147 is located proximate the first end 145a, i.e., the inlet, of the duct 144. The blades 152 can be sized so that minimal clearance exists between the tips of the blades 152 and the adjacent surface of the skin 143 (after accounting for lengthwise expansion of the blades 152 due to operational effects such as thermal and centrifugal expansion), to help maximize the aerodynamic efficiency of the anti-torque device 140.

The secondary rotor 147 has a maximum diameter denoted in FIG. 3 by the reference character “dmax.” The ratio of the maximum diameter dmax to the length L of the duct 144 can be approximately 1.5:1 to approximately 2.0:1. These specific values are presented for exemplary purposes only; the ratio can of dmax to L can be less than approximately 1.5:1, and greater than approximately 2.0 in alternative embodiments. Because the anti-torque device is located directly beneath the rotational arc of the main rotor blades 17, the distance between the axis of rotation of the main rotor assembly 14 and the axis of rotation of the secondary rotor 147 is less than half the maximum diameter of the main rotor assembly 14.

The secondary rotor 147 is driven by a drive shaft 153, and a gearbox 154 that transmits torque from the drive shaft 153 to the rotor 147. The gearbox 154 also permits the pitch of the blades 152 to be varied in response to pilot inputs. The drive shaft 153 is driven the engines 19 via the transmission and an intermediate gearbox (not shown) mounted on the fuselage, near the anti-torque device 140. The drive shaft 153 is housed within a tube 155, as shown in FIG. 3. The tube 155 extends into the duct 144 by way of an opening formed in the frame 142 and the skin 143. The gearbox 154 and the secondary rotor 147 are suspended from the tube 55, as depicted in FIG. 3.

The rotation of the secondary rotor 147 causes the anti-torque device 140 to produce an aerodynamic force directed substantially perpendicular to the longitudinal axis of the rotary-wing aircraft 10, i.e., in the “y” direction. This force counteracts the torque generated by the main rotor 14. The anti-torque force generated by the anti-torque device 140 can be varied by varying the pitch angle of the blades 152 of the secondary rotor 147 in response to inputs from the pilot provided, for example, via foot pedals. Thus, the anti-torque force generated by the anti-torque device 140, in addition to countering the torque generated by the main rotor 14, can be used to provide directional control of the aircraft 10 about its vertical (z-direction), or yaw axis. The direction of the airflow through the duct 144 resulting from the rotation of the secondary rotor 147 is denoted by the arrow 159 in FIG. 3.

The aircraft 10 can also include two stabilizers 160 located on opposite sides of the fuselage 12, as illustrated in FIG. 2. Each stabilizer 160 includes a horizontal portion 162 mounted on the fuselage 12, and a vertical portion 164 mounted on the outboard end of the horizontal portion 162. The horizontal portion 162 of each stabilizer 160 adds stability to the aircraft 10 about its pitch axis. The position of each horizontal portion 162 in relation to the fuselage 12 can be adjusted independently, in response to pilot inputs, to help trim the aircraft 10 about its pitch and roll axes.

The vertical portion 164 of each stabilizer 160 adds stability to the aircraft 10 about its yaw axis. Moreover, the yaw, i.e., z-direction, force generated by the vertical portions 164 can reduce the magnitude of the anti-torque moment that the anti-torque device 140 needs to produce in order to stabilize the aircraft 10 about its yaw axis. The position of each vertical portion 164 in relation to the fuselage 12 can be adjusted in response to pilot inputs, to help trim the aircraft 10 about its yaw axis in flight.

Integrating the anti-torque device 140 into the fuselage 12 as disclosed herein eliminates the need for a tail section, or tail boom. Eliminating the tail section, in turn, eliminates the extra weight and drag associated with the tail section. Moreover, because the tail section of a conventional rotary-wing aircraft is generally located well aft of the aircraft's center of gravity, the elimination of the tail section can result in a substantial forward shift in the aircraft's empty-weight center of gravity. Eliminating the tail boom also removes restrictions the length of the main rotor blades 19 because, unlike in a tail-boom mounted anti-torque device, there is no potential for interference between the blades 19 and the blades 152 of the secondary rotor 147.

Shifting the center of gravity of a rotary-wing aircraft forward, in general, can potentially improve the controllability, and the passenger and cargo capacity of the aircraft, and can provide the designer with greater flexibility in positioning the engines, transmission, and other equipment. Shifting the center of gravity forward can also potentially reduce the amount of cyclic control (and engine power) needed to sustain level flight.

The more-forward center of gravity of the aircraft 10 in relation to a comparable rotary-wing aircraft of conventional design can allow more of the cabin of the aircraft 10 to be used for useful load, e.g., passengers and cargo. More specifically, the more-forward center of gravity of the aircraft 10 in its empty-weight configuration can permit the aft portion of the cabin to be used to accommodate passengers and cargo without exceeding the aft-limit for the center of gravity.

The more-forward center of gravity of the aircraft 10 also provides more flexibility in the placement of the engines and transmission of the aircraft 10. For example, most if not all new and large rotary-wing aircraft with front-drive engines use a canted tail rotor in which the plane of rotation of the tail-rotor blades is angled in relation to the vertical direction, so that the tail rotor provides a lift component in addition to an anti-torque moment. This feature is necessary to compensate for the relatively rearward center of gravity in such aircraft. This center-of-gravity constraint gives designers of such aircraft relatively little flexibility in placing the engines and transmission of the aircraft at an optimal location with respect to the longitudinal (lengthwise) direction of the aircraft. The more-forward center of gravity of the aircraft 10 disclosed herein, by contrast, can facilitate placement of the engines and transmission at a more favorable location than may otherwise be possible.

Moreover, because the use of the anti-torque device 140 eliminates the need for a conventional tail rotor, there is no need to limit the length of the main rotor blades 19 to avoid overlap between the blades 19 and the tail rotor. Also, because the anti-torque device 140 is integrated with the fuselage 12, the anti-torque device 140 does not significantly increase the frontal area of the aircraft 10, or the component of aerodynamic drag associated with the frontal area. Thus, unlike a ducted anti-torque rotor mounted on a tail boom, the anti-torque device 140 can have a duct of sufficient length to achieve the optimal diameter-to-length ratio of 1.5:1 to 2:1 noted above, without a significant penalty in aerodynamic drag.

The effective center of thrust of the anti-torque device 140 is located closer to the main rotor 14 than the center of thrust of a conventional anti-torque device mounted on a tail boom. While the smaller effective moment arm of the anti-torque device 140 reduces the net anti-torque moment generated by the anti-torque device 140 in comparison to a tail-boom mounted anti-torque device, it is believed that the relatively high thrust produced by the anti-torque device 140 due to its ducted arrangement compensates at least in part for the smaller moment arm, and can thereby permit the anti-torque device 140 to produce a sufficient anti-torque moment without a significant increase in the engine power.

What is claimed is:

1. A rotary-wing aircraft, comprising:
a fuselage having a cabin that spans substantially an entire length of the fuselage;
a rotor assembly mounted on the fuselage for rotation about a first axis extending in a first direction, the rotor assembly comprising a mast, a hub mounted on the mast, and a plurality of blades mounted on the hub;
an engine mounted on the fuselage, wherein the engine is mechanically coupled to the rotor assembly and is operative to generate a torque that causes the rotor assembly to rotate; and
an anti-torque device comprising: a body contiguous with the fuselage and defining a duct; and a rotor mounted within the duct for rotation about a second axis extending in a second direction.

2. The rotary-wing aircraft of claim 1, wherein the blades of the rotor assembly rotate in a plane of rotation, and the anti-torque device is positioned directly beneath the plane of rotation.

3. The rotary-wing aircraft of claim 1, wherein the first and second directions are substantially perpendicular.

4. The rotary-wing aircraft of claim 1, wherein the rotor of the anti-torque device has a maximum diameter, the duct has a length, and a ratio of the maximum diameter to the length is in the range of approximately 1.5 to approximately 2.0.

5. The rotary-wing aircraft of claim 1, wherein the body comprises a frame and a skin mounted on the frame, and the skin defines the duct.

6. The rotary-wing aircraft of claim 5, wherein the frame is substantially cylindrical.

7. The rotary-wing aircraft of claim 1, wherein the rotor of the anti-torque device comprises a hub, and a plurality of blades mounted on the hub of the anti-torque device.

8. The rotary-wing aircraft of claim 1, wherein the engine is mechanically coupled to the rotor of the anti-torque device and is operative to generate a torque that causes the rotor of the anti-torque device to rotate.

9. The rotary-wing aircraft of claim 1, wherein the secondary rotor is operative to generate a torque that counteracts a torque exerted on the fuselage in response to the torque that causes the rotor assembly to rotate.

10. The rotary-wing aircraft of claim 1, wherein a distance between an axis of rotation of the rotor assembly and an axis of rotation of the secondary rotor is less than one-half of a maximum diameter of the rotor assembly.

11. The rotary-wing aircraft of claim 1, wherein the rotor of the anti-torque device is positioned proximate an end of the duct.

12. The rotary-wing aircraft of claim 1, further comprising a first and a second stabilizer mounted on opposite sides of the fuselage, wherein the first and second stabilizers each includes a horizontal portion mounted on the fuselage and configured to pivot in relation to the fuselage, and a vertical portion mounted on an outboard end of the horizontal portion.

13. A rotary-wing aircraft, comprising:
a fuselage having a cabin that spans substantially an entire length of the fuselage;
a rotor assembly mounted for rotation on the fuselage, the rotor assembly comprising a mast, a hub mounted on the mast, and a plurality of blades mounted on and extending radially outward from the hub;
an engine mounted on the fuselage, wherein the engine is mechanically coupled to the rotor assembly and is operative to generate a torque that causes the rotor assembly to rotate; and
an anti-torque device comprising: a body mounted on the fuselage and defining a duct;
and a secondary rotor mounted for rotation within the duct, wherein: the secondary rotor is operative to generate a torque that counteracts a torque exerted on the fuselage in response to the torque that causes the rotor assembly to rotate; and a distance between an axis of rotation of the rotor assembly and an axis of rotation of the secondary rotor is less than one-half of a maximum diameter of the rotor assembly.

14. The rotary-wing aircraft of claim 13, wherein the blades of the rotor assembly generate a downwash when rotating, and the anti-torque device is positioned within the downwash.

15. The rotary-wing aircraft of claim 13, wherein the blades of the rotor assembly rotate in a plane of rotation, and the anti-torque device is positioned directly beneath the plane of rotation.

16. The rotary-wing aircraft of claim 13, wherein the body of the anti-torque device is contiguous with the fuselage.

17. The rotary-wing aircraft of claim 13, wherein the rotor of the anti-torque device has a maximum diameter, the duct has a length, and a ratio of the maximum diameter to the length is in the range of approximately 1.5 to approximately 2.0.

18. A rotary-wing aircraft, comprising:
a fuselage having a cabin that spans substantially an entire length of the fuselage;
a rotor assembly mounted for rotation on the fuselage, the rotor assembly comprising: a mast; a hub mounted on the mast; and a plurality of blades mounted on and extending radially outward from the hub;
an engine mounted on the fuselage, wherein the engine is mechanically coupled to the rotor assembly and is operative to generate a torque that causes the rotor assembly to rotate; and
an anti-torque device comprising: a body mounted on the fuselage and defining a duct; and a secondary rotor mounted for rotation in the duct and operative to generate a force substantially perpendicular to a longitudinal axis of the fuselage, wherein a ratio of a maximum diameter of the secondary rotor to a length of the duct is approximately 1.5 to approximately 2.0.

19. The rotary-wing aircraft of claim 9, wherein the body of the anti-torque device is contiguous with the fuselage.

20. The rotary-wing aircraft of claim 9, wherein the rotor of the anti-torque device has a maximum diameter, the duct has a length, and a ratio of the maximum diameter to the length is in the range of approximately 1.5 to approximately 2.0.
